(19) United States
(12) Patent Application Publication
(10) Pub. No.: US 2011/0289304 A1
(43) Pub. Date: Nov. 24, 2011

(54) SYSTEMS, METHODS, AND COMPUTER PROGRAM PRODUCTS FOR CONFIGURING NETWORK SETTINGS

(76) Inventors: John Peters, Coon Rapids, MN (US); Robert Bergerson, Blaine, MN (US); James Heit, Vadnais Height, MN (US); Jason Schultz, Plymouth, MN (US)

(21) Appl. No.: 12/783,695

(22) Filed: May 20, 2010

(51) Int. Cl. G06F 9/00

(52) U.S. Cl. 713/1

(57) ABSTRACT

A computer program product having a computer readable medium tangibly recording computer program logic for managing configurations in a computer system is disclosed. The computer program product includes code to configure network information in a first Operating System (OS) environment, code to pass the network information to a second OS environment, and code to effectuate the network information in the first and second OS environments without rebooting the first and second OS environments.

### TECHNICAL FIELD

The present disclosure relates generally to computing systems and, more specifically, to configuring network settings in distributed computing systems.

### BACKGROUND OF THE INVENTION

Information technology systems are essential to any modern business. These systems have grown more and more complex. Today they can include distributed centers located anywhere from a few miles apart to those across the continent or in separate countries. Today, personal computers are common and many businesses employ multiple operating systems from various vendors. Often systems are dispersed in branch offices running critical applications or containing essential data.

FIG. 1 is an illustration of a conventional distributed computing system 100. The system 100 includes Operating System (OS) 1 and OS 2. Within OS 1 is a system controller 130 that manages a system that uses OS 2. The system controller 130 includes an emulator 120 and a communication program 110. The communication program 110 is shown as a single program, though in various systems it includes multiple modes running simultaneously, and each mode has its own Network Interface Cards (NICs) 150 that are not shared with the other modes.

The system controller 130 communicates with the disk management application 140, and the disk management application 140 includes a network parameter configuration program 145. The network parameter configuration program 145 has a Graphical User Interface (GUI) that allows a human user to configure the NICs 150, routers, and Internet Protocol (IP) addresses in the system 100. The NICs 150 communicate with devices (not shown) under OS 2 and off-system devices (not shown) as well.

The traffic cop program 160 manages the OS 2 environment for the communication program 110. Specifically, the traffic cop program 160 is a mediator between the OS 2 environment at the NICs 150, the communication program 110, and other OS 1 resources. In a particular example, the traffic cop program 160 reports changes occurring in the OS 2 system back to the communication program 110.

As the configuration process is currently handled in the conventional system 100, any changes to the network configuration (i.e., changes to NICs, IP addresses, and/or routers) are written to configuration files that are instantiated when the traffic cop program 160 is rebooted. To restart the traffic cop program 160, the system controller 130 must also be rebooted. This effectively means the OS 1 environment must be rebooted to make network changes effective. Needless to say, this is considered undesirable by the user. For these and other reasons, improvements are desirable.

### BRIEF SUMMARY OF THE INVENTION

In one aspect, a computer program product having a computer readable medium tangibly recording computer program logic for managing configurations in a computer system is disclosed. The computer program product includes code to configure network information in a first Operating System (OS) environment, code to pass the network information to a second OS environment, and code to effectuate the network information in the first and second OS environments without rebooting the first and second OS environments.

In another aspect, a system for managing network configurations in a computing system is disclosed. The system includes a first functional unit that generates network configuration information for the distributed computing system in a first Operating System (OS) environment, a second functional unit that passes the network configuration information from the first OS environment to the second OS environment, and a third functional unit that effectuates the network configuration information in the first OS environment without restarting the first OS environment.

Furthermore, a system for managing network configurations in a distributed computer platform is disclosed. The system includes means for configuring network changes in the first OS environment and means for implementing the network changes in the first OS environment and the second OS environment without restarting one of the first and second OS environments.

In yet another aspect, a computer implemented method for managing network configurations in a distributed computing system is disclosed. The method includes effectuating network changes in the first OS environment, without rebooting the first OS environment, and passing the network changes to the second OS environment.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of a conventional distributed computing system.

FIG. 2 is a block diagram of an operational system for managing a large distributed computing system adapted according to one example embodiment.

FIG. 3 illustrates an exemplary distributed computer system, adapted according to one embodiment, which can be arranged as shown in FIG. 2.

FIG. 4 is an illustration of an exemplary process, adapted according to one embodiment, for configuring hardware devices

### DETAILED DESCRIPTION OF THE INVENTION

According to various embodiments, the network is configured using functional units that can recognize configuration changes without having to reboot either the OS 1 or OS 2 environment. Example embodiments are described in more detail below.

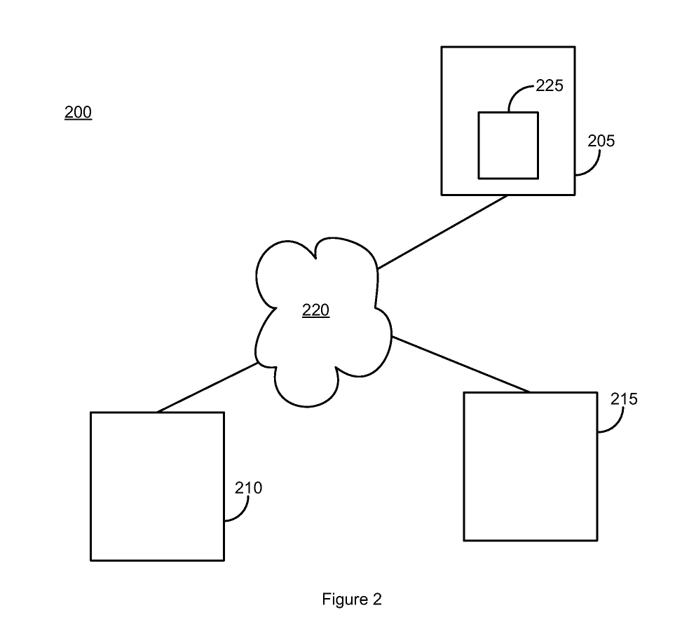

FIG. 2 is a block diagram of an operational system for managing a large distributed computing system 200 adapted according to one example embodiment. Preferably, the system 200 includes a server system 205, a managed system 210, and a client system 215, as is well known in the art. The server system 205, managed system 210, and the client system 215 preferably communicate with one another over a network 220, which can be any suitable network such as a LAN, WAN, or any other network.

In one possible embodiment, the server system 205 acts as a maintenance processing system and/or a utility monitoring processing system that functions to monitor the activities and health of the components, processes, and tasks executing within the managed system 210. The managed system 210 performs the processing desired by the operators of the managed system 210. Client systems, such as system 215, are processing systems utilized by operators of the managed system 210 to view operations, maintenance and health information regarding the components, processes and tasks in the managed system 210.

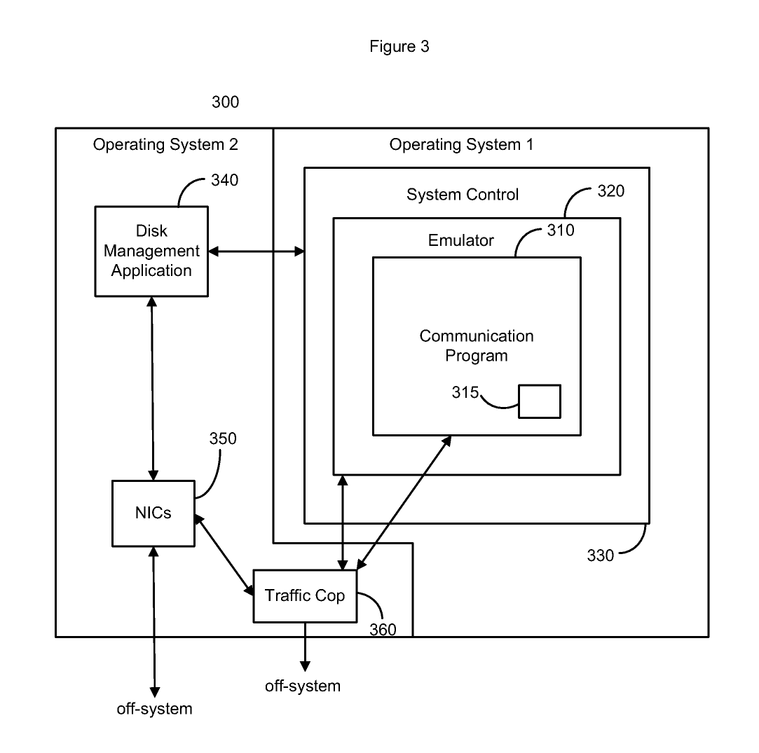

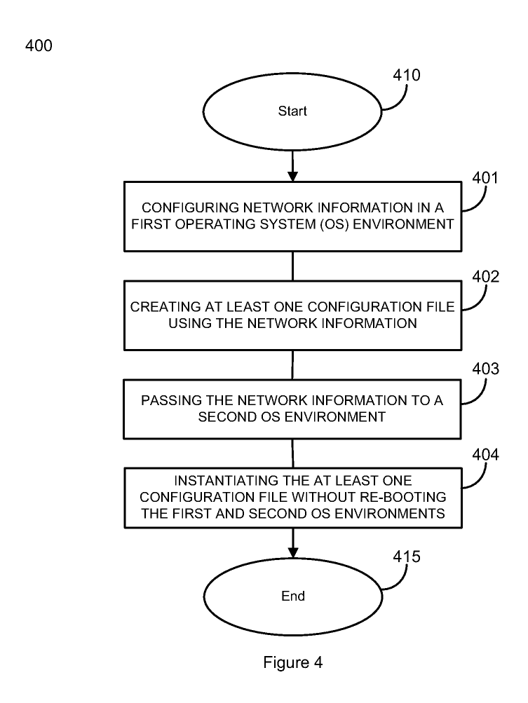

In this example, the server system 205 runs a first OS (e.g., a proprietary OS), and the managed system 210 and the client system 215 run a second operating system (e.g., Linux). In various embodiments, the server system 205 runs a network configuration program 225 that configures routers, NICs, IP addresses, and other network characteristics within the system 200, as described in more detail below with respect to FIGS. 3 and 4.

In the embodiment shown in FIG. 2, these three systems are shown to be separate processing systems. One of ordinary skill in the art will recognize that these systems may be implemented to operate on one as well as numerous hardware systems without deviating from the spirit and scope of the present invention as recited within the attached claims.

FIG. 3 illustrates an exemplary distributed computer system 300, adapted according to one embodiment, which can be arranged as shown in FIG. 2. The OS 1 environment includes the system control module 330, the emulator 320, and the communication program 310. The system control module 330 is used to control the system 300, even though the system 300 has disparate OSs and multiple computers. In one example, the system control module 330 includes a program that is run on a server system, such as the server system 205 of FIG. 2. In one example, OS 1 is a proprietary OS, and OS 2 is a more commonly used OS, such as Linux, Windows, Unix, or the like.

The system 300 also includes the disk management application 340, which communicates with the system control module 330 and the NICs 350. The NICs 350 interface one or more modes of the communication program 310 with a network (e.g., a IP network) in the OS 2 environment. The traffic cop program 360 reports changes in the OS 1 environment to the OS 2 environment and vice-versa.

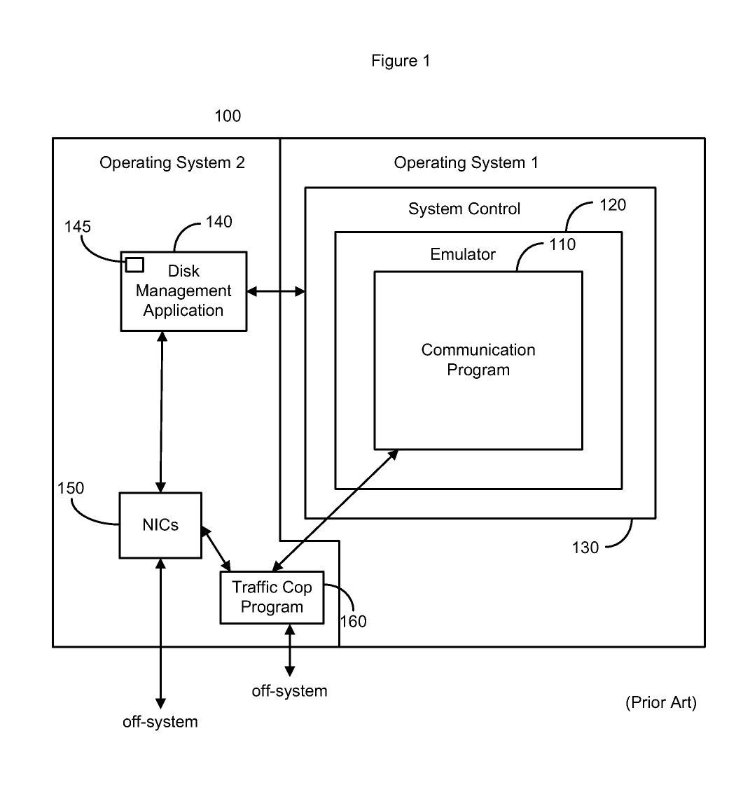

A notable difference between the system 100 of FIG. 1 and the system 300 of FIG. 3 is that the system 300 places the network parameter configuration program 315 within the communication program 310. The configuration program 315 creates configuration files that incorporate the network configuration. In this embodiment, the configuration files are instantiated in system control 330 at their creation. Network configuration information is then passed to the traffic cop program 360 in the OS 2 environment, where it is effectuated in the OS 2 environment. Therefore, network configuration changes can be made without requiring a reboot of either the OS 1 or OS 2 environment.

Network Interface Cards (NICs) and IP addresses used by the configuration program 315 are configured in the configuration program 315, rather than in the disk management application 340 (as in FIG. 1). Such feature allows NIC interface, IP address configuration, and router configuration changes to become effective when the configuration program 315 is restarted.

Various embodiments include advantages over the conventional system of FIG. 1. For instance, various embodiments can be rebooted less often, since network configuration changes performed in the communication program 310 are effective without rebooting. Less frequent rebooting can translate to less downtime and more efficiency. Additionally, many users of the conventional system of FIG. 1 manually move network configurations to a standby computer for safety during reboot. The embodiment of FIG. 3 does not reboot at network configuration changes in the configuration program 315 and thereby ameliorates the user's motivation to manually move the network configuration to a standby system. Thus, various embodiments are more convenient for network administrators than is the system of FIG. 1.

In the embodiment of FIG. 3, configuration statements are added to the configuration program 315 to replace the information that is no longer configured using the disk management application 340. Such configuration statements include those allowing a user to add, remove, and/or modify configurations for NICs, IP addresses, and routers. However, the scope of embodiments is not so limited, as any network configurations that can be handled by a communication program in a system controller may be implemented within the communication program.

The configuration program 315 passes down configuration parameters to the traffic cop program 360. It is the responsibility of the traffic cop program 360 to sift through the OS 2 network configurations and the network configurations from the configuration program 315 and determine the network settings therefrom. The traffic cop program reports the network settings and status to the configuration program 315 in an asynchronous response. If an OK status is received by the configuration program 315 from the traffic cop program 340, then the network configuration is complete, and processes are allowed to attach to the communication program 310. The OS 2 environment uses configuration information from the traffic cop program 360 as well. In some embodiments, such as those that use Linux as the OS 2, the configuration information is implemented in the OS 2 environment with no reboot.

FIG. 4 is an illustration of an exemplary process 400, adapted according to one embodiment, for configuring hardware devices. The process 400 may be performed by a computer, such as a computer in the server system 205 of FIG. 2, as it executes code.

The process 400 begins at block 410. At block 401, network information is configured in a first OS environment. In one example, a Graphical User Interface (GUI) is provided for a human user to enter network configuration changes into the system. The network information can include any type of network information including, but not limited to, NIC information, router information, IP address information, and the like.

At block 402, at least one configuration file is created using the network information. The communication program 310 reads a configuration file that resides in the first OS environment. The communication program 310 then parses the configuration file and puts the information into a packet. The packet is then moved from memory in the first OS environment and into memory of the second OS environment, where it is parsed, and configuration files are created in the second OS environment.

At block 403, the network information is passed to a second OS environment. In one example, the first OS environment implements control and management functions for a distributed computing system. The first OS environment includes a proprietary OS that runs a variety of control and management programs, where a human user accesses one or more of the control and management programs to manage the distributed computing system. The second OS environment receives at least a subset of the network information from the first OS environment.

At block 404, the at least one configuration file is instantiated. In one example, the traffic cop program 360 gets the packet from the communication program 310 (via the first OS environment). The traffic cop program 360 parses through the configuration information in the packet and uses the information to create and write configuration files for the NICs 350 on the system in the second OS environment. At this point, the NICs 350 are configured and available in the second OS environment for use by the communication program 310 in the first OS environment. The process 400 ends at block 415.

The process 400 is exemplary, and it is understood that other embodiments may add, rearrange, omit, or modify one or more actions. For example, in various embodiments, the process 400 is performed from time to time to take into account subsequent changes to network configurations.

It is recognized that the above systems and methods operate using computer hardware and software in any of a variety of configurations. Such configurations can include computing devices, which generally include a processing device, one or more computer readable media, and a communication device. Other embodiments of a computing device are possible as well. For example, a computing device can include a user interface, an operating system, and one or more software applications. Several example computing devices include a personal computer (PC), a laptop computer, or a personal digital assistant (PDA). A computing device can also include one or more servers, one or more mass storage databases, and/or other resources.

A processing device is a device that processes a set of instructions. Several examples of a processing device include a microprocessor, a central processing unit, a microcontroller, a field programmable gate array, and others. Further, processing devices may be of any general variety such as reduced instruction set computing devices, complex instruction set computing devices, or specially designed processing devices such as an application-specific integrated circuit device.

Computer readable media includes volatile memory and non-volatile memory and can be implemented in any method or technology for the storage of information such as computer readable instructions, data structures, program modules, or other data. In certain embodiments, computer readable media is integrated as part of the processing device. In other embodiments, computer readable media is separate from or in addition to that of the processing device. Further, in general, computer readable media can be removable or non-removable. Several examples of computer readable media include, RAM, ROM, EEPROM and other flash memory technologies, CD-ROM, digital versatile disks (DVD) or other optical storage, magnetic cassettes, magnetic tape, magnetic disk storage or other magnetic storage devices, or any other medium that can be used to store desired information and that can be accessed by a computing device. In other embodiments, computer readable media can be configured as a mass storage database that can be used to store a structured collection of data accessible by a computing device.

A communications device establishes a data connection that allows a computing device to communicate with one or more other computing devices via any number of standard or specialized communication interfaces such as, for example, a universal serial bus (USB), 802.11 a/b/g network, radio frequency, infrared, serial, or any other data connection. In general, the communication between one or more computing devices configured with one or more communication devices is accomplished via a network such as any of a number of wireless or hardwired WAN, LAN, SAN, Internet, or other packet-based or port-based communication networks.

The above specification, examples and data provide a complete description of the manufacture and use of the composition of the invention. Since many embodiments of the invention can be made without departing from the spirit and scope of the invention, the invention resides in the claims hereinafter appended.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer program product having a computer readable medium tangibly recording computer program logic for managing configurations in a computer system, the computer program product comprising:
code to configure network information in a first Operating System (OS) environment; and
code to pass the network information to a second OS environment; and
code to effectuate the network information in the first and second OS environments without rebooting the first and second OS environments.

2. The computer program product of claim 1 in which the code to configure network information comprises:
code to create at least one configuration file using the network information; and further in which the code to effectuate the network information comprises:
code to instantiate the least one configuration file without rebooting the first and second OS environments.

3. The computer program product of claim 1 in which the code to pass the network information comprises:
code to pass changes from the second OS environment to the first OS environment.

4. The computer program product of claim 1 in which the code to effectuate the network information comprises:
code to restart a communication program within an emulator of the first OS environment.

5. The computer program product of claim 1 in which the first OS environment comprises:
code to implement a communication program that configures the network information;
code to implement an emulator in which the communication program runs; and
code to implement a system controller in which the emulator runs, the system controller controlling a distributed computer system that spans the first and second OS environments.

6. The computer program product of claim 1 in which the network information comprises at least one of:
Network Interface Card (NIC) information;
Internet Protocol (IP) information; and
router information.

7. A system for managing network configurations in a distributed computing system, the system comprising:
a first functional unit that generates network configuration information for the distributed computing system in a first Operating System (OS) environment;
a second functional unit that passes the network configuration information from the first OS environment to the second OS environment; and
a third functional unit that effectuates the network configuration information in the first OS environment without restarting the first OS environment.

8. The system of claim 7 further comprising:
a fourth functional unit that effectuates the network configuration information in the second OS environment without restarting the second OS environment.

9. The system of claim 7 in which the network configuration information comprises at least one of:
Network Interface Card (NIC) information;
Internet Protocol (IP) information; and
router information.

10. The system of claim 7 in which the second functional unit comprises:
a module that passes changes from the second OS environment to the first OS environment.

11. The system of claim 7 in which the first functional unit creates at least one configuration file using the network configuration information, and in which the third functional unit instantiates the least one configuration file.

12. The system of claim 7 in which the first and third functional units are run in a system controller that controls the distributed computing system, the computing system spanning the first and second OS environments.

13. A system for managing network configurations in a distributed computer platform, the distributed computer platform spanning a first Operating System (OS) environment and a second OS environment, the system comprising:
means for configuring network changes in the first OS environment; and
means for implementing the network changes in the first OS environment and the second OS environment without restarting one of the first and second OS environments.

14. The system of claim 13 in which the configuring means comprises means for creating a configuration file from the network changes; and in which the implementing means comprises means for instantiating the configuration file by restarting a computer program within the first OS environment.

15. The system of claim 13 in which in which the network changes comprise at least one of:
Network Interface Card (NIC) changes;
Internet Protocol (IP) information changes; and
router changes.

16. The system of claim 13 in which the implementing means comprises:
means for passing the network changes to the second OS environment.

17. The system of claim 13 in which the configuring means comprises a Graphical User Interface (GUI) accepting user input.

18. A computer implemented method for managing network configurations in a distributed computing system that spans a first Operating System (OS) environment and a second OS environment, the distributed computing system managed from the first OS environment, the method comprising:
effectuating network changes in the first OS environment without rebooting the first OS environment; and
passing the network changes to the second OS environment.

19. The method of claim 18 further comprising:
effectuating the network changes in the second OS environment without rebooting the second OS environment.

20. The method of claim 18 in which effectuating network changes comprises:
creating at least one configuration file that includes information about the network changes; and
instantiating the at least one configuration file upon creation thereof.
